(19) United States
(12) Patent Application Publication
(10) Pub. No.: US 2014/0289688 A1
(43) Pub. Date: Sep. 25, 2014

(54) METHOD AND SYSTEM FOR TESTING DIRECT CURRENT TRANSMISSION LAYOUT OF PRINTED CIRCUIT BOARD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: Yu-Hsu LIN, Santa Clara, CA (US); Jeng-Da WU, New Taipei (TW); Guang-Feng OU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/064,525

(22) Filed: Oct. 28, 2013

(30) Foreign Application Priority Data
Mar. 19, 2013 (CN) 2013100873287

(51) Int. Cl. G06F 17/50

(52) U.S. Cl. CPC G06F 17/5081
USPC 716/112

(57) ABSTRACT

An system for testing direct current (DC) layout of a printed circuit board, the system includes a layout information obtaining module, a rule loading module, a test script building module, a script executing module, and a report generating module. The layout information obtaining module obtains layout information of the printed circuit board. The rule loading module load DC transmission rules. The test script building module builds a DC transmission test scrip of the printed circuit board according to one of the DC transmission rules. The script executing module executes the DC transmission test script to determine whether the layout information of the printed circuit board complies with the one of the DC transmission rules. The report generating module generates a DC transmission testing report depicting whether the layout information of the printed circuit board complies with the one of the DC transmission rules and displays the testing report.

### BACKGROUND

1. Technical Field

The disclosure generally relates to methods and systems for testing direct current transmission layout of a printed circuit board.

2. Description of Related Art

A printed circuit board often has a plurality of integrated chips (ICs). There are massive power supply traces connecting electronic components, such as capacitors, resistors, and copper coils to the integrated chips. Each of the integrated chips is powered by a normal direct current. When the integrated chips are not able to function normally, the values of the electronic components need to be adjusted accordingly. Thus, the design of the layout of the printed circuit board is required to comply with predetermined rules. However, existing testing technologies depends very much on human experiences and judgments, which may not be accuracy or efficient.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of one embodiment of a system.

FIG. 2 is a block diagram of one embodiment of the DC transmission layout testing unit of FIG. 1.

FIG. 3 is a flowchart showing one embodiment of a DC layout testing method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

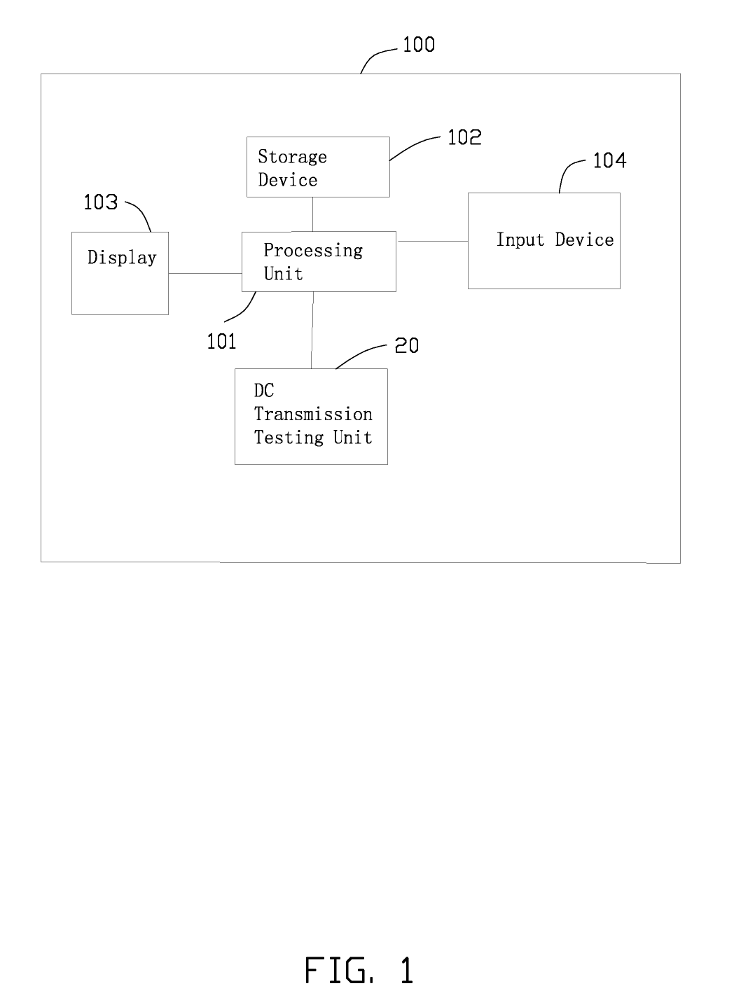

FIG. 1 shows one embodiment of a system 100 includes a processing unit 101, a storage device 102, a display 103, an input device 104 and a direct current (DC) transmission testing unit 20. The system 100 may be a host computer, a server computer, a tablet computer, or the like.

The processing unit 101 is coupled to the storage device 102, the display 103, the input device 104, and the DC transmission layout testing unit 20. The processing unit 101 may include one or more processors that provide the processing capability to execute the operating system, programs, user and application interfaces. The DC transmission layout testing unit 20 is executable by the processing unit 101, and is configured for testing DC transmission layout of a printed circuit board.

The storage device 102 may store a variety of information and may be used for various purposes. For example, the storage device 102 may store various programs, applications, user interface functions, and processor functions, for example.

The display 103 may provide a visual output interface between the system 100 and a user. The visual output may include text, graphics, video, and any combination thereof. The display 103 may use LCD (liquid crystal display) technology, or LPD (light emitting polymer display) technology, although other display technologies may be used in other embodiments.

The input device 104 may provide an input interface between the system 100 and a user. The input device 104 may be a keyboard, a mouse or a touch pad, which can be used to input information.

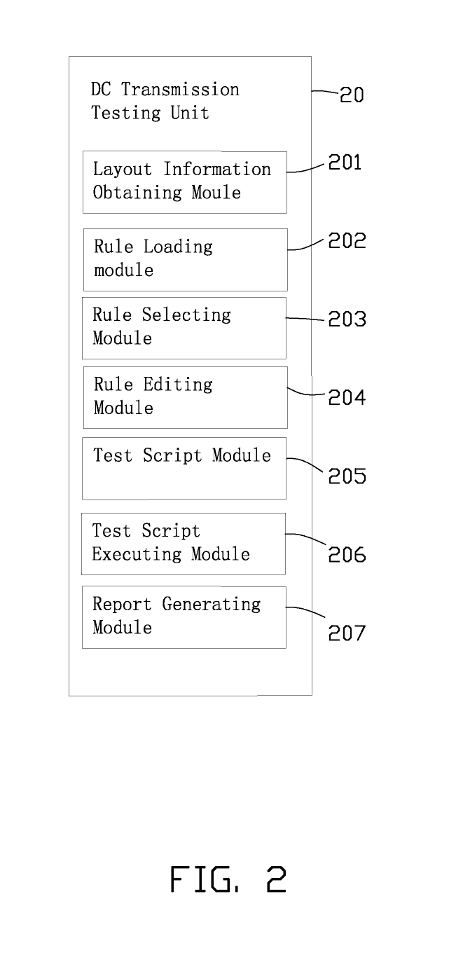

FIG. 2 shows a functional block diagram of one embodiment of the DC transmission layout testing unit 20. The DC transmission layout testing unit 20 may include a layout information obtaining module 201, a rule loading module 202, a rule selecting module 203, a rule editing module 204, a test script building module 205, a test script executing module 206, and a report generating module 207.

The layout information obtaining module 201 may obtain layout information of a printed circuit board. The layout information may include component names, trace names, and copper coil widths.

The rule loading module 202 may load DC transmission rules from a rule library, which may be stored in the storage device 102. The rule selecting module 203 may display the DC transmission rules in the display 103 and allow a user to select a rule of them. For example, one rule defines a requirement of parameter of the printed circuit board layout, which pertain to and follow certain standards, such as requiring a theoretical input voltage U0=12V, and an input tolerance IT=+/−1%; a theoretical output voltage U1=12V, and output tolerance OT=+/−5%; and a copper coil width W1.

The rule editing module 204 may display the rule and allow a user to edit the rule. The user may add a new rule, or delete a rule, or modify the DC transmission rules.

The test script building module 205 may build a DC transmission test script of the printed circuit board according to the rule.

The script executing module 206 may execute the DC transmission test script to determine whether the layout information of the printed circuit board complies with the rule.

The report generating module 207 may generate a DC transmission testing report depicting whether the layout information of the printed circuit board complies with the rule. For example, the testing report may include an actual output voltage U2. Therefore the width copper coil W2 can be adjusted as following:

W2=W1×ΔU1/ΔU2 (2); ΔU1=U2−U1, ΔU2=U1×(OT−IT).

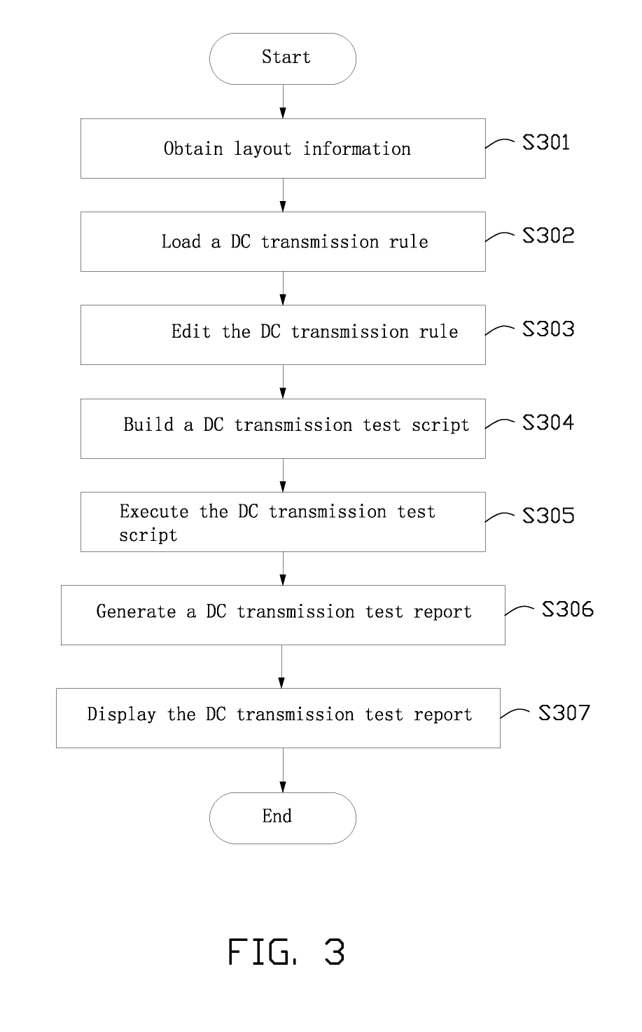

FIG. 3 is a flowchart showing one embodiment of a method for testing DC transmission layout of a printed circuit board. The method comprises the following steps.

In step S301, the layout information obtaining module 201 may obtain layout information of a printed circuit board. The layout information may include component names, trace names, and copper coil widths.

In step S302, the rule loading module 202 may load DC transmission rules from a rule library, which may be stored in the storage device 102. The rule selecting module 203 may display the DC transmission rules in the display 103 and allow a user to select a rule from the DC transmission rules. For example, one rule defines a requirement of parameter of the printed circuit board layout, which pertain to and follow certain standards, such as requiring a theoretical input voltage U0=12V, and an input tolerance IT=+/−1%; a theoretical output voltage U1=12V, and output tolerance OT=+/−5%; and a copper coil width W1.

In step S303, the rule editing module 204 may enable editing the rule. The user may add a new predetermined rule, or delete a predetermined rule, or modify the DC transmission rules.

In step S304, the test script building module 205 may build a DC transmission test script of the printed circuit board according to the rule.

In step S305, the script executing module 206 may execute the DC transmission test script to determine whether the layout information of the printed circuit board complies with the rule.

In step S306, the report generating module 207 may generate a DC transmission testing report depicting whether the layout information of the printed circuit board complies with the rule. For example, the testing report may include an actual output voltage U2. Therefore the width cooper coil W2 can be adjusted as following:

W2=W1×ΔU1/ΔU2 (2); ΔU1=U2−U1, ΔU2=U1×(OT−IT).

In step S307, the display 103 may display the DC transmission test report.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

In particular, depending on the embodiment, certain steps or methods described may be removed, others may be added, and the sequence of steps may be altered. The description and the claims drawn for or in relation to a method may give some indication in reference to certain steps. However, any indication given is only to be viewed for identification purposes, and is not necessarily a suggestion as to an order for the steps.

What is claimed is:

1. A system for testing direct current (DC) layout of a printed circuit board, the system comprising:
a layout information obtaining module configured to obtain layout information of the printed circuit board;
a rule loading module configured to load DC transmission rules;
a test script building module configured to build a DC transmission test scrip of the printed circuit board according to one of the DC transmission rules;
a script executing module configured to execute the DC transmission test script to determine whether the layout information of the printed circuit board complies with the one of the DC transmission rules;
a report generating module configured to generate a DC transmission testing report depicting whether the layout information of the printed circuit board complies with the one of the DC transmission rules; and
a display configured to display the DC transmission testing report.

2. The system of claim 1, further comprising a rule selecting module, wherein the display is configured to display the DC transmission rules, and the rule selecting module is configured to select a rule from the DC transmission rules.

3. The system of claim 2, further comprising a rule editing module, wherein the rule editing module is configured to enable editing the rule.

4. The system of claim 3, wherein the rule editing module is further configured to enable adding a new rule to the DC transmission rules.

5. The system of claim 3, wherein the rule editing module is further configured to enable modifying the DC transmission rules.

6. A method for testing direct current (DC) layout of a printed circuit board, the method comprising:
obtaining layout information of the printed circuit board;
loading DC transmission rules;
building a DC transmission test scrip of the printed circuit board according to one of the DC transmission rules;
executing the DC transmission test script to determine whether the layout information of the printed circuit board complies with the one of DC transmission rules;
generating a DC transmission testing report depicting whether the layout information of the printed circuit board complies with the one of the DC transmission rules; and
displaying the DC transmission testing report.

7. The method of claim 6, wherein the method further comprises:
selecting a rule from the DC transmission rules.

8. The method of claim 7, wherein the method further comprises:
enabling editing the rule through the display.

9. The method of claim 6, wherein the method further comprises:
enabling adding a new DC transmission rule through the display.

10. The method of claim 6, wherein the method further comprises:
enabling modifying the DC transmission rules through the display.
